(19) United States
(12) Patent Application Publication
(10) Pub. No.: US 2025/0341762 A1
(43) Pub. Date: Nov. 6, 2025

(54) GIMBAL APPARATUS FOR IMAGING, GIMBAL IMAGE PICKUP APPARATUS, AND CONTROL METHOD

(71) Applicant: CANON KABUSHIKI KAISHA, Tokyo (JP)

(72) Inventor: MAKOTO OIKAWA, Kanagawa (JP)

(21) Appl. No.: 19/266,423

(22) Filed: Jul. 11, 2025

Related U.S. Application Data
(63) Continuation of application No. PCT/JP2023/039808, filed on Nov. 6, 2023.

(30) Foreign Application Priority Data
Jan. 20, 2023 (JP) 2023-007616

(51) Int. Cl. G03B 17/56; F16M 11/12; F16M 11/18; H04N 23/695; H04N 23/80

(52) U.S. Cl. CPC G03B 17/561; F16M 11/123; F16M 11/18; H04N 23/695; H04N 23/80

(57) ABSTRACT

A gimbal apparatus includes a first drive unit configured to rotate a first support portion about a first axis, a second drive unit configured to rotate a second support portion supporting an imaging unit about a second axis, a third drive unit configured to rotate the imaging unit about a third axis, a detector configured to detect a rotation angle about the third axis. In a case where the rotation angle exceeds a predetermined angle during imaging, the gimbal apparatus drives the first drive unit so that the second drive unit rotates to an opposite position to the second-axis orthogonal plane while the imaging unit continues to perform imaging, and drives the third drive unit so that the rotation angle from the second-axis orthogonal plane to an opposite side of the second drive unit with respect to the opposite position is the predetermined angle.

### CROSS-REFERENCE TO RELATED APPLICATIONS

This application is a Continuation of International Patent Application No. PCT/JP2023/039808, filed on Nov. 6, 2023, which claims the benefit of Japanese Patent Application No. 2023-007616, filed on Jan. 20, 2023, both of which are hereby incorporated by reference herein in their entirety.

### BACKGROUND

### Field of the Technology

The present disclosure relates to a gimbal apparatus for imaging having a gimbal mechanism.

### Description of the Related Art

Japanese Patent Application Laid-Open No. 2022-065624 discloses a gimbal apparatus that stabilizes the attitude (orientation) of an image pickup apparatus using a gimbal mechanism serving as a three-axis rotation mechanism. Since this gimbal apparatus prevents an imaging light beam from being shielded by the gimbal structure that connects a pitch axis and a roll axis in a case where a rotation angle (pitch angle) around the pitch axis closest to the image pickup apparatus increases, the roll axis and yaw axis can be inverted.

However, the gimbal apparatus disclosed in Japanese Patent Application Laid-Open No. 2022-065624 requires the user to stop imaging and manually invert the roll axis and yaw axis in a case where the pitch angle increases during imaging.

### SUMMARY

A gimbal apparatus according to one aspect of the disclosure includes a body portion, a first drive unit configured to rotate a first support portion relative to the body portion about a first axis, a second drive unit configured to rotate a second support portion supporting an imaging unit about a second axis orthogonal to the first axis relative to the first support portion, a third drive unit configured to rotate the imaging unit about a third axis orthogonal to the first axis and the second axis relative to the second support portion, a detector configured to detect a rotation angle about the third axis that an optical axis of the imaging unit makes relative to a second-axis orthogonal plane orthogonal to the second axis and including the third axis, a memory storing instructions, and a processor that, upon execution of the instructions, is configured to control the first drive unit, the second drive unit, and the third drive unit. In a case where the rotation angle becomes higher than a predetermined angle from the second-axis orthogonal plane toward a second drive unit side during imaging by the imaging unit, the processor is configured to drive the first drive unit so that the second drive unit rotates to an opposite position to the second-axis orthogonal plane while the imaging unit continues to perform imaging, and drive the third drive unit so that the rotation angle from the second-axis orthogonal plane to an opposite side of the second drive unit with respect to the opposite position is the predetermined angle. A gimbal image pickup apparatus having the above gimbal apparatus also constitutes another aspect of the disclosure. A control method of the above gimbal apparatus also constitutes another aspect of the disclosure. A storage medium storing a program that causes a computer to execute the above control method also constitutes another aspect of the disclosure.

Features of the present disclosure will become apparent from the following description of embodiments with reference to the attached drawings. The following description of embodiments will be provided by way of example.

### BRIEF DESCRIPTION OF THE DRAWINGS

FIG. 1 illustrates the configuration of a gimbal camera according to this embodiment.

FIGS. 2A and 2B illustrate the external appearance of the gimbal camera.

FIGS. 3A, 3B, 3C, and 3D explain the operation in a case where the third-axis rotation angle θ₃ exceeds a threshold value θ₃₀.

FIGS. 4A, 4B, 4C, and 4D explain changes in operation depending on angle-of-view information.

FIGS. 5A, 5B, 5C, and 5D explain vertical inversion of a movable unit when inverted around the first axis.

FIGS. 6A, 6B, and 6C explain vertically inverted recording operation in a case where vertical attitude inversion is detected.

FIG. 7 explains an operation of connecting and recording images before and after a rotation operation.

FIGS. 8A and 8B are flowcharts illustrating processing executed by the gimbal camera.

FIGS. 9A, 9B, 9C, and 9D explain shielding of imaging light beams in prior art.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments according to the disclosure.

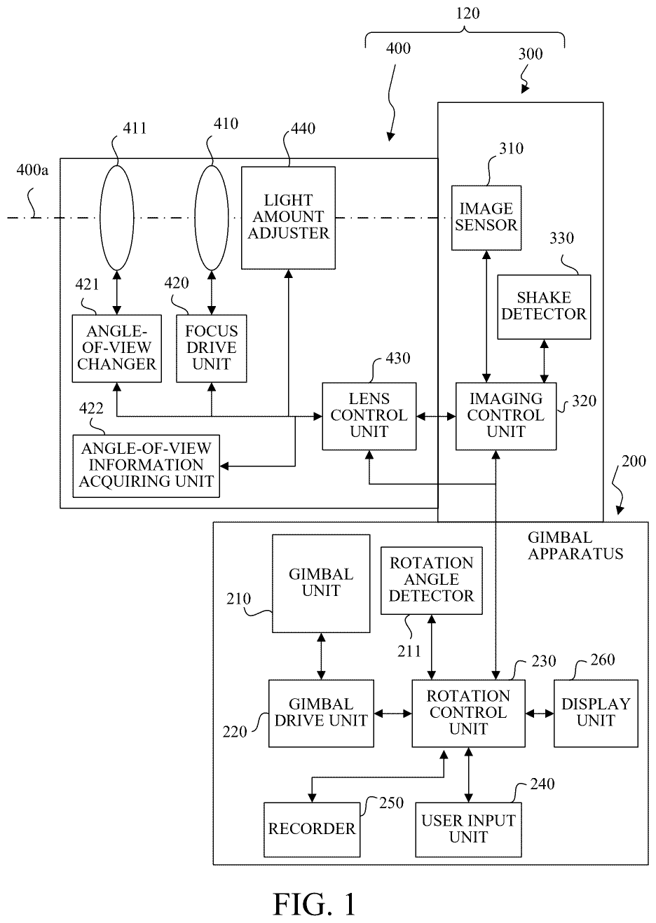

FIG. 1 illustrates the configuration of a gimbal camera (gimbal image pickup apparatus) according to a first embodiment. The gimbal camera includes a gimbal apparatus 200 and a movable unit 120. The movable unit 120 is an imaging unit that includes a camera 300 that performs imaging and a lens unit 400 that houses an optical system, and the gimbal apparatus 200 supports the movable unit 120 movably (rotatably). The gimbal apparatus 200, the camera 300, and the lens unit 400 may be integrated with, or attachable to and detachable from each other. The gimbal apparatus may support a general (general-purpose) lens interchangeable type single-lens reflex or mirrorless camera, a lens integrated type camera, a smartphone with a camera function, or the like, as an imaging unit.

The gimbal apparatus 200 has a gimbal unit 210 configured to change the attitude of the movable unit 120 around three mutually orthogonal rotation central axes described later, a gimbal drive unit 220 configured to drive the gimbal unit 210, and a rotation control unit 230 configured to control the gimbal drive unit 220. The rotation control unit 230, which serves as a control unit, controls the gimbal drive unit 220, thereby enabling image stabilizing drive and panning drive of the movable unit 120. The gimbal unit 210 and the gimbal drive unit 220 constitute a rotator.

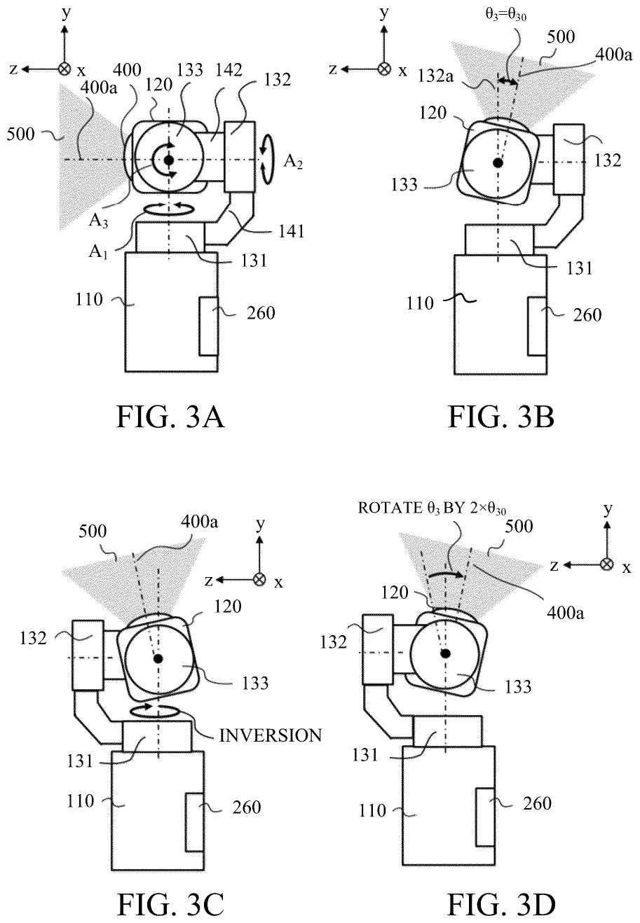

The gimbal apparatus 200 further includes a rotation angle detector 211, a user input unit 240, a recorder 250, and a display unit 260. As illustrated in FIGS. 3A and 3B, the rotation angle detector 211 detects a third-axis rotation angle θ₃, which is an angle between a plane 132a that is orthogonal to a second axis A₂ and includes the third axis A₃ (referred to as a second-axis orthogonal plane hereinafter) and an optical axis 400a of the optical system in the lens unit 400.

The rotation control unit 230 accepts user input from the user input unit 240 operable by the user. This user input is reflected in the control of the gimbal unit 210. The rotation control unit 230 communicates with an imaging control unit 320 of the camera 300, receives an image (video) acquired by imaging, and records the image in the recorder 250. The recorder 250 also stores angle-of-view information, which will be described later, and threshold information associated with the angle-of-view information.

The display unit 260 displays an image input via the rotation control unit 230 as a processing unit. The rotation control unit 230 is electrically connected to the imaging control unit 320 and a lens control unit 430 in the lens unit 400, and receives the respective states and setting conditions of the gimbal apparatus 200, the camera 300, and the lens unit 400, and displays them on the display unit 260.

The camera 300 includes an image sensor 310 configured to photoelectrically convert (capture) an optical image formed by the optical system in the lens unit 400, an imaging control unit 320 configured to control the image sensor 310, and a shake detector 330 configured to detect a shake (angular velocity and acceleration) of the movable unit 120. The shake detector 330 as a determining unit has a function of determining the up and down attitude of the movable unit 120 by detecting the direction of gravitational acceleration. The imaging control unit 320 is electrically connected to the rotation control unit 230 described above, and sends camera information including an image acquired based on an output signal from the image sensor 310 to the rotation control unit 230. The imaging control unit 320 is also electrically connected to the lens control unit 430, and communicates various information with the lens control unit 430.

Although not illustrated, an image stabilizing mechanism may be provided in the camera 300, which shifts the image sensor 310 in a direction orthogonal to the optical axis 400a to perform an image stabilizing operation.

The optical system in the lens unit 400 includes a plurality of optical elements such as a zoom lens 411, a focus lens 410, and an aperture stop (not illustrated). The lens unit 400 includes an angle-of-view changer 421 that drives the zoom lens 411 in a direction in which the optical axis 400a extends (an optical axis direction), and an angle-of-view information acquiring unit 422 that acquires angle-of-view information of the optical system according to the position of the zoom lens 411. The lens unit 400 further includes a focus drive unit 420 configured to drive the focus lens 410, and the lens control unit 430 configured to control the angle-of-view changer 421 and the focus drive unit 420.

The gimbal camera according to this embodiment further includes a microphone (not illustrated) provided in any of the gimbal apparatus 200, the camera 300, and the lens unit 400, and can acquire audio.

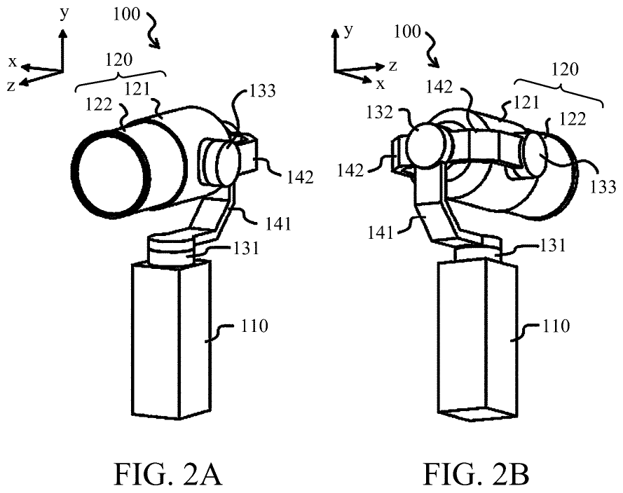

FIGS. 2A and 2B illustrate the external appearance of the gimbal camera 100 according to this embodiment. The gimbal apparatus 200 includes a grip portion 110 as a body portion to be held by the user. The grip portion 110 houses the rotation control unit 230 and the recorder 250 illustrated in FIG. 1, and although not illustrated in FIGS. 2A and 2B, the user input unit 240 and the display unit 260 illustrated in FIG. 1 are provided on the outer surface of the grip portion 110.

The movable unit 120 includes a connection tube 121 rotatably connected to third-axis rotator 133 (described later), and a movable tube 122 that can move (back and forth) in the optical axis direction relative to connection tube 121. The camera 300 illustrated in FIG. 1 is housed inside connection tube 121. The movable tube 122 moves back and forth relative to the connection tube 121 in accordance with a change in the zoom state of lens unit 400 illustrated in FIG. 1.

The gimbal apparatus rotates the movable unit 120 around the three rotation central axes as described above. The gimbal apparatus 200 includes a first arm (first support portion) 141, a second arm 142 (second support portion), a first-axis rotator (first-axis rotation drive unit) (first drive unit) 131, a second-axis rotator (second-axis rotation drive unit) (second drive unit) 132, and a third-axis rotator (third-axis rotation drive unit) (third drive unit) 133, each of which is a gimbal structure. The first arm 141 connects the first-axis rotator 131 and the second-axis rotator 132, and the second arm 142 connects the second-axis rotator 132 and the third-axis rotator 133. The first-axis rotator 131 rotates (pans) the first arm 141, i.e., the movable unit 120, around the y-axis relative to the grip portion 110. The second-axis rotator 132 rotates (tilts) the second arm 142, i.e., the movable unit 120, around the z-axis relative to the first arm 141. The third-axis rotator 133 drives the movable unit 120 to rotate (roll) around the x-axis relative to the second arm 142. The movable unit 120 can be tilted around three axes relative to the grip portion 110 by being connected to the grip portion 110 via the first-axis to third-axis rotators 131 to 133.

The first-axis to third-axis rotators 131 to 133 constitute the gimbal drive unit 220 illustrated in FIG. 1, and the first and second arms 141 and 142 constitute the gimbal unit 210.

The rotation central axes of pan, tilt, and roll have been described here using the x-axis, y-axis, and z-axis in FIGS. 2A and 2B. However, the rotation central axes of pan, tilt, and roll change according to the attitude of the movable unit 120, for example, because in a case where the movable unit 120 is rotated by 90 degrees in the roll direction from the attitude illustrated in FIGS. 2A and 2B, the axis of the third-axis rotator 133 becomes the y-axis.

Next follows a description of the image stabilizing operation of the gimbal camera 100 according to this embodiment. The gimbal camera 100 tilts due to the tilt of the user's hand gripping the grip portion 110. It also shakes due to the shake of the gripping hand itself (hand shake) and a user motion such as walking. Thereby, an image captured by the camera 300 may tilt and shake.

Thus, this embodiment controls the spatial attitude of the movable unit 120 by the rotational drive of the first-axis to third-axis rotators 131 to 133, stabilizes an image captured by the camera 300 at a certain tilt, and reduces image blur. For example, this embodiment controls an image so that it is always horizontal regardless of the tilt of the user's hand, and controls it so as to acquire an image with less image blur regardless of shake. The operation of suppressing these tilts and image blur will be called an image stabilizing operation.

Apart from the image stabilizing operation by the first-axis to third-axis rotators 131 to 133, image stabilizing operation may be performed by driving the focus lens 410 using the focus drive unit 420 or by shifting the image sensor 310 in the camera 300 described above.

A description will now be given of a panning operation, a tilting operation, and a rolling operation in the gimbal camera 100 according to this embodiment. In a case where the above user input instructs a panning operation, the rotation control unit 230 illustrated in FIG. 1 drives the first-axis rotator 131. Thereby, the spatial attitude (rotation position) of the camera 300 can be changed in the pan direction, and an imaging angle of view of the camera 300 is changed in the pan direction. In a case where the user input instructs a tilting operation, the rotation control unit 230 drives the third-axis rotator 133. Thereby, the spatial attitude of the camera 300 can be changed in the tilt direction, and the imaging angle of view of the camera 300 is changed in the tilt direction. In a case where the user input instructs a roll operation, the rotation control unit 230 drives the second-axis rotator 132. Thereby, the spatial attitude of the camera 300 can be changed in the roll direction, and the imaging angle of the camera 300 is changed in the roll direction.

The rotation control unit 230 can also control the driving of the first-axis to third-axis rotators 131 to 133 so as to change the attitude of the camera 300 in the pan, tilt and roll directions and track a specific object (e.g., a moving object) in the image acquired by the camera 300.

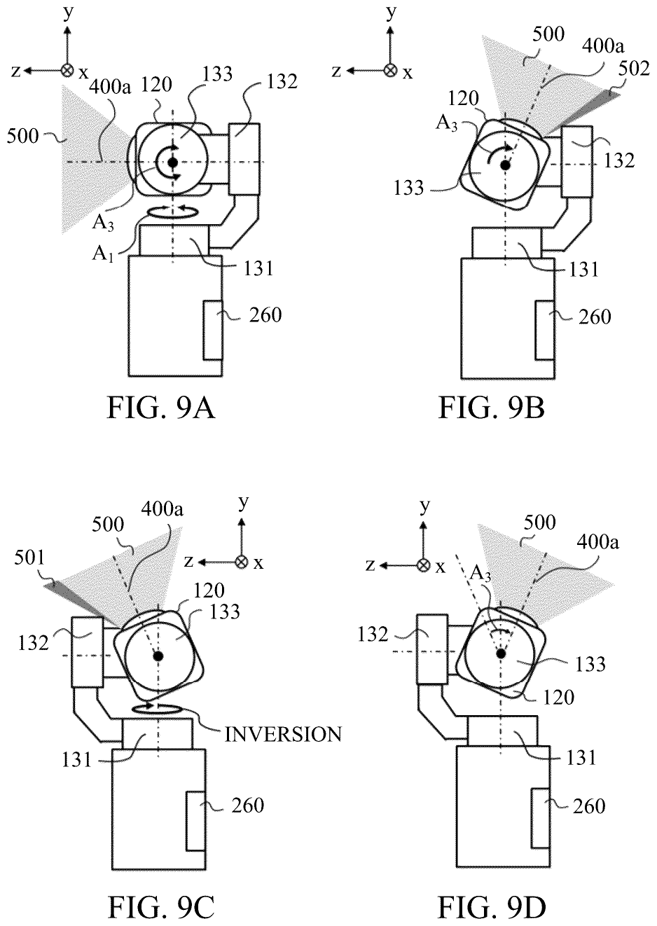

Referring now to FIGS. 9A, 9B, 9C, and 9D, a description will be given of the shielding of the imaging light beam that occurs in the conventional gimbal camera. FIGS. 9A, 9B, 9C, and 9D illustrate the conventional gimbal camera as viewed from the −x direction. Those elements, which are corresponding elements in the conventional gimbal camera, will be designated by the same reference numerals as those in FIGS. 2A and 2B.

FIG. 9A illustrates a state in which the movable unit 120 in the conventional gimbal camera faces the +z direction. The optical axis 400a in the lens unit 400 extends in the +z direction. A₁, A₂, and A₃ respectively represent the first axis, the second axis, and the third axis as the rotation central axes of the first-axis rotator 131, the second-axis rotator 132, and the third-axis rotator 133. An imaging light beam 500 enters the optical system in the lens unit 400. In the state illustrated in FIG. 9A, the imaging light beam 500 is not shielded.

FIG. 9B illustrates a state in which the movable unit 120 has been rotated by 90° or more in the clockwise direction around the third axis A₃ (x-axis) from the state illustrated in FIG. 9A by driving the third-axis rotator 133. In this state, a part 502 of the imaging light beam 500 is shielded due to the second-axis rotator 132. As a result, the second-axis rotator 132 appears in an image captured by the camera 300, and the image quality is degraded.

Thus, in a conventional gimbal camera, the user is to temporarily suspend imaging and rotate the first-axis rotator 131 from the state illustrated in FIG. 9B to the state illustrated in FIG. 9C to invert (reversely rotate) the movable unit 120. Moreover, as illustrated in FIG. 9D, the third-axis rotator 133 is to be rotated until the orientation of the movable unit 120 becomes the same as that illustrated in FIG. 9B. These operations must be performed by the gimbal camera through the user's input operation, which is arduous for the user. Furthermore, imaging is to be suspended.

Referring now to FIGS. 3A, 3B, 3C, and 3D, a description will be given of the operation of the gimbal camera 100 according to this embodiment. FIGS. 3A, 3B, 3C, and 3D illustrate the gimbal camera 100 according to this embodiment when viewed from the −x direction.

FIG. 3A illustrates a state in which the movable unit 120 of the gimbal camera 100 faces the +z direction. The optical axis 400a in the lens unit 400 extends in the +z direction. As in FIG. 9A, A₁, A₂, and A₃ respectively represent the first axis, the second axis, and the third axis as the rotation central axes of the first-axis rotator 131, second-axis rotator 132, and third-axis rotator 133. An imaging light beam 500 enters the optical system in lens unit 400. In the state of FIG. 3A, the imaging light beam 500 is not shielded. In addition, the display unit 260 is provided on the outer surface of the grip portion 110. In FIGS. 3A, 3B, 3C, and 3D, display unit 260 faces the −Z direction. In the state of FIG. 3A, the imaging light beam 500 is not shielded.

FIG. 3B illustrates a state in which the movable unit 120 has been rotated by 90° or more in the clockwise direction around third axis A₃ by driving the third-axis rotator 133 from the state of FIG. 3A. In this embodiment, a rotation angle of the optical axis 400a around the third axis A₃ relative to the second-axis orthogonal plane 132a, which is orthogonal to the second axis A₂ that is the rotation central axis of the second-axis rotator 132 and includes the third axis A₃, will be referred to as a third-axis rotation angle θ₃. FIG. 3B illustrates a state in which the third-axis rotation angle θ₃ has reached a threshold value θ₃₀, which is a predetermined angle from the second-axis orthogonal plane 132a toward the second-axis rotator side (second drive unit side).

In a case where the third-axis rotation angle θ₃ reaches the threshold value θ₃₀ in this manner, the rotation control unit 230 rotates the first-axis rotator 131 around the first axis A₁ as illustrated in FIG. 3C to invert the movable unit 120. Thereby, the second-axis rotator 132 moves to a position opposite to the position in the state of FIG. 3B relative to the second-axis orthogonal plane 132a (third axis A₃).

As illustrated in FIG. 3D, the rotation control unit 230 rotates the third-axis rotator 133 by 2×θ₃₀ from the state of FIG. 3C around the third axis A₃ so that the third-axis rotation angle θ₃ is θ₃₀ on the opposite side of the second-axis orthogonal plane 132a to the second-axis rotator 132 located at the opposite position. Thereby, the attitude of the movable unit 120 can be the same as that of FIG. 3B. Since the position of the second-axis rotator 132 in the state of FIG. 3D is opposite to the position in the state of FIG. 3B with respect to the second-axis orthogonal plane 132a, the movable unit 120 can further rotate in the clockwise direction around the third axis A₃ without causing the imaging light beam 500 to be shielded.

In the gimbal camera 100 according to this embodiment, a series of operations from the state of FIG. 3B to the state of FIG. 3C and then to the state of FIG. 3D is automatically performed under control of the rotation control unit 230 without requiring user input. Thereby, the user can concentrate on imaging without worrying about shielding of the imaging light beam 500 caused by the second-axis rotator 132.

Thus, in a case where the third-axis rotation angle θ₃ becomes higher than the threshold value θ₃₀, the rotation control unit 230 drives the first-axis rotator 131 so that the second-axis rotator 132 rotates to the opposite position, and controls the third-axis rotator 133 to be driven by 2×θ₃₀ in the opposite side of the second-axis rotator 132. Thereby, shielding of the imaging light beam 500 caused by the second-axis rotator 132 can be avoided without requiring the user to perform arduous input operations or interrupt imaging.

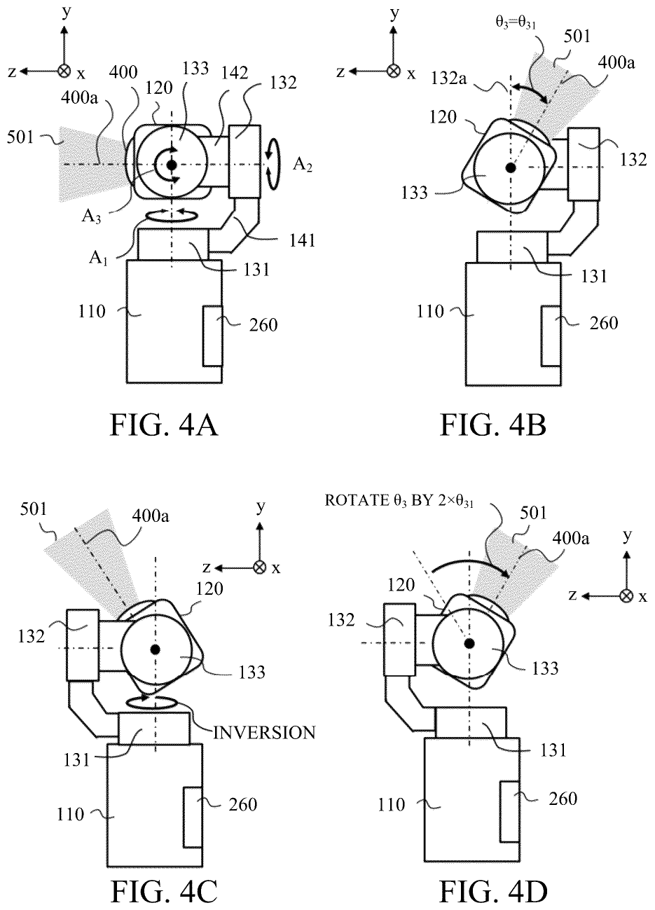

The gimbal camera 100 according to this embodiment changes a threshold value of the third-axis rotation angle θ₃ based on the angle-of-view information of the lens unit 400. This will be discussed using FIGS. 4A, 4B, 4C, and 4D. FIGS. 4A, 4B, 4C, and 4D also illustrate the gimbal camera 100 according to this embodiment viewed from the −x direction. FIGS. 4A, 4B, 4C, and 4D illustrate a state in which the angle of view of the lens unit 400 is narrower on the telephoto side than that in FIGS. 3A, 3B, 3C, and 3D.

FIG. 4A illustrates a state in which the movable unit 120 faces the +z direction. An imaging light beam 501 enters the lens unit 400 from an angle of view narrower than that of the imaging light beam 500 in FIG. 3A. In FIG. 4A, the imaging light beam 501 is not shielded.

FIG. 4B illustrates a state in which the movable unit 120 has been rotated by 90° or more in the clockwise direction around the third axis A₃ (x-axis) by driving the third-axis rotator 133 from the state in FIG. 4A. In FIG. 4B, an angle that the optical axis 400a makes around the third axis A₃ relative to the second-axis orthogonal plane 132a that is orthogonal to the second axis A₂ of the second-axis rotator 132 and includes the third axis A₃ will be referred to as a third-axis rotation angle θ₃. FIG. 4B illustrates a state in which the third-axis rotation angle θ₃ has reached a threshold value θ₃₁, which is a predetermined value from the second-axis orthogonal plane 132a toward the second-axis rotator side. The threshold value θ₃₁ is greater than the threshold value θ₃₀.

In a case where the third-axis rotation angle θ₃ has reached the threshold value θ₃₁ in this manner, the rotation control unit 230 rotates the first-axis rotator 131 about the first axis A₁ to invert the movable unit 120, as illustrated in FIG. 4C. Thereby, the second-axis rotator 132 moves to a position opposite to the position in the state of FIG. 4B with respect to the third axis A₃.

As illustrated in FIG. 4D, the rotation control unit 230 further rotates the third-axis rotator 133 by 2×θ₃₁ from the state of FIG. 3C about the third axis A₃ so that the third-axis rotation angle θ₃ becomes θ₃₁ on the opposite side from the second-axis orthogonal plane 132a to the second-axis rotator 132 at the opposite position. Thereby, the attitude of the movable unit 120 to be the same as that illustrated in FIG. 4B. Since the position of the second-axis rotator 132 in the state of FIG. 4D is opposite to the position in the state of FIG. 4B with respect to the second-axis orthogonal plane 132a, the movable unit 120 can further rotate in the clockwise direction around the third axis A₃ without causing the imaging light beam 501 to be shielded.

In a case where the lens unit 400 has a narrow angle of view, the imaging light beam 501 by the second-axis rotator 132 is less likely to be shielded. Thus, the rotation control unit 230 sets the threshold value θ₃₁ to be greater than the threshold value θ₃₀. Thereby, the frequency of the operation of transitioning from the state of FIG. 4B to the state of FIG. 4D can be reduced via the state of FIG. 4C. Thus, changing the threshold value for driving the first-axis and third-axis rotators 131 and 133 according to the angle of view of the lens unit 400 can reduce the frequency of driving the first-axis and third-axis rotators 131 and 131.

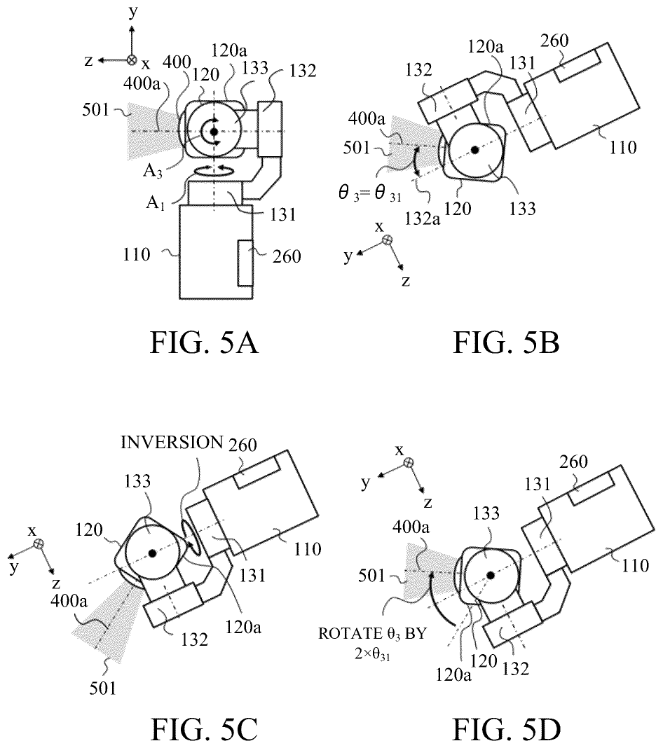

Referring now to FIGS. 5A, 5B, 5C, and 5D, a description will be given of a case where the movable unit 120 is inverted upside down. FIGS. 5A, 5B, 5C, and 5D also illustrate the gimbal camera 100 according to this embodiment when viewed from the −x direction.

FIG. 5A illustrates a state in which the movable unit 120 faces the +z direction, and an upper surface 120a of the movable unit 120 faces the y-axis direction. In FIG. 5A, the imaging light beam 501 is not shielded.

FIG. 5B illustrates a state in which the grip portion 110 has rotated by 90° or more in the counterclockwise direction around the third axis A₃ (x-axis) from the state in FIG. 5A, and further the movable unit 120 is slightly tilted in the clockwise direction around the x-axis relative to the +z direction in FIG. 5A. In FIG. 5B, an angle that the optical axis 400a makes around the third axis A₃ relative to the second-axis orthogonal plane 132a, which is orthogonal to the second axis A₂ of the second-axis rotator 132 and includes the third axis A₃, will be referred to as a third-axis rotation angle θ₃.

In a case where the movable unit 120 rotates around the third axis A₃ and the third-axis rotation angle θ₃ from the second-axis orthogonal plane 132a toward the second-axis rotator side reaches the threshold value θ₃₁, the rotation control unit 230 rotates the first-axis rotator 131 around the first axis A₁ as illustrated in FIG. 5C to invert the movable unit 120. Thereby, the second-axis rotator 132 moves to a position opposite to the position in the state of FIG. 5B with respect to the third axis A₃.

As illustrated in FIG. 5D, the rotation control unit 230 rotates the third-axis rotator 133 by 2×θ₃₁ from the state in FIG. 4C around the third axis A₃ so that the third-axis rotation angle θ₃ is θ₃₁ on the opposite side of the second-axis rotator 132 located at the opposite position from the second-axis orthogonal plane 132a. Thereby, the attitude of the movable unit 120 can be the same as that in FIG. 5B. Moreover, since the position of the second-axis rotator 132 in the state in FIG. 5D is opposite to the position in the state in FIG. 5B with respect to the second-axis orthogonal plane 132a, the movable unit 120 can further rotate in the clockwise direction around the third axis A₃ without causing the imaging light beam 501 to be shielded.

In the state in FIG. 5D, the upper surface 120a of the movable unit 120 is located on the lower side. In other words, the attitude of the movable unit 120 is upside down from the attitude in FIG. 5A. Thus, an image captured by the camera 300 is also upside down.

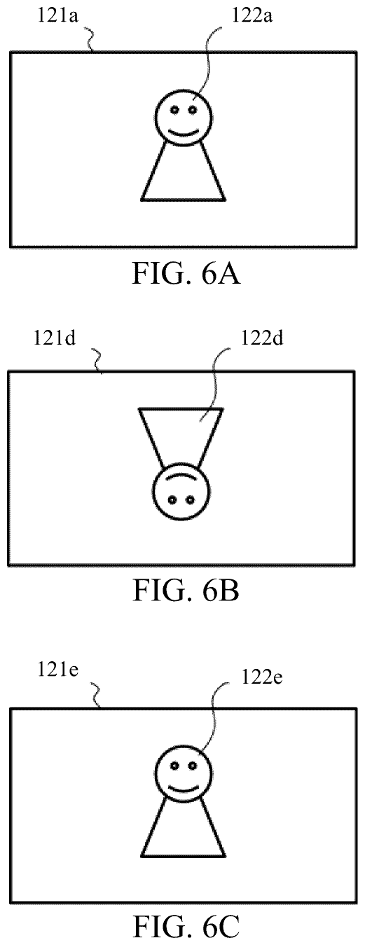

FIG. 6A illustrates an image 121a captured by the camera 300 in the state of FIG. 5A. In the image 121a, an object 122a is captured in the same vertical attitude as that when the user views it with his eyes. In the state of FIG. 5A, image 121a is stored in the recorder 250 in the same up-down attitude.

FIG. 6B illustrates an image 121d captured by camera 300 in the state of FIG. 5D before it is vertically inverted (upside down). In the image 121d, an object 122d is captured in an attitude that is vertically inverted (upside down) from the object viewed by the user with his eyes.

In such a case, the rotation control unit 230 in this embodiment inverts the object 122d upside down to generate an image 121e, as illustrated in FIG. 6C, and stores it in the recorder 250. Thereby, an upside-down image can be prevented from being stored in the recorder 250 in a case where imaging is performed in the state of FIG. 5D.

The image displayed on the display unit 260 in a case where imaging is performed in the state of FIG. 5D is also the image 121e illustrated in FIG. 6C. Thereby, the vertical attitude of the object 122e displayed on the display unit 260 can match the vertical attitude of the object viewed by the user with his eyes.

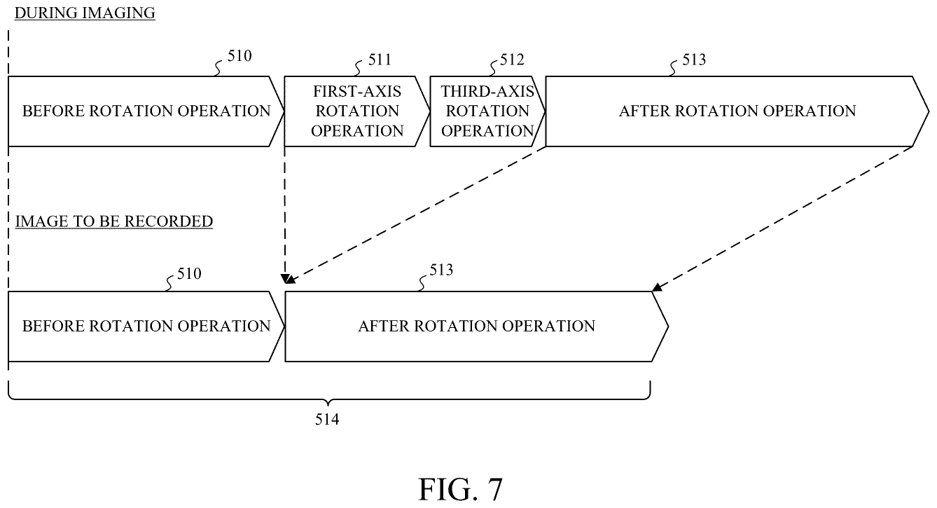

FIG. 7 illustrates the operation of the rotation control unit 230 connecting and recording an image acquired before the first-axis and third-axis rotators 131 and 133 are driven (before the rotation operation) and an image acquired after they are driven (after the rotation operation). The horizontal axis represents time, the upper row represents the image acquired by imaging, and the lower row represents the image recorded in the recorder 250.

An image 510 before the rotation operation illustrated in the upper row is an image acquired by imaging in the state of FIG. 3A or FIG. 3B. An image 511 is an image acquired by imaging while the first-axis rotator 131 is rotated around the first axis A₁ and transitions from the state of FIG. 3B to the state of FIG. 3C. An image 512 is an image captured while the third-axis rotator 133 is rotating around the third axis A₃ so that the third-axis rotation angle θ₃ is 2×θ₃₀, and transitions from the state of FIG. 3C to the state of FIG. 3D. An image 513 is an image captured in the state of FIG. 3D after the rotation operation of the third-axis rotator 133 is completed.

The images 511 and 512 while the first-axis and third-axis rotators 131 and 133 are rotated are unnecessary images. Thus, the rotation control unit 230 deletes the images 511 and 512 and records a combined image 514 in the recorder 250 by connecting the image 510 before the rotation operation and the image 513 after the rotation operation. Thereby, the user can concentrate on imaging without worrying about shielding caused by the gimbal structure, and automatically store high-quality images from which unnecessary images during the rotation operation have been removed.

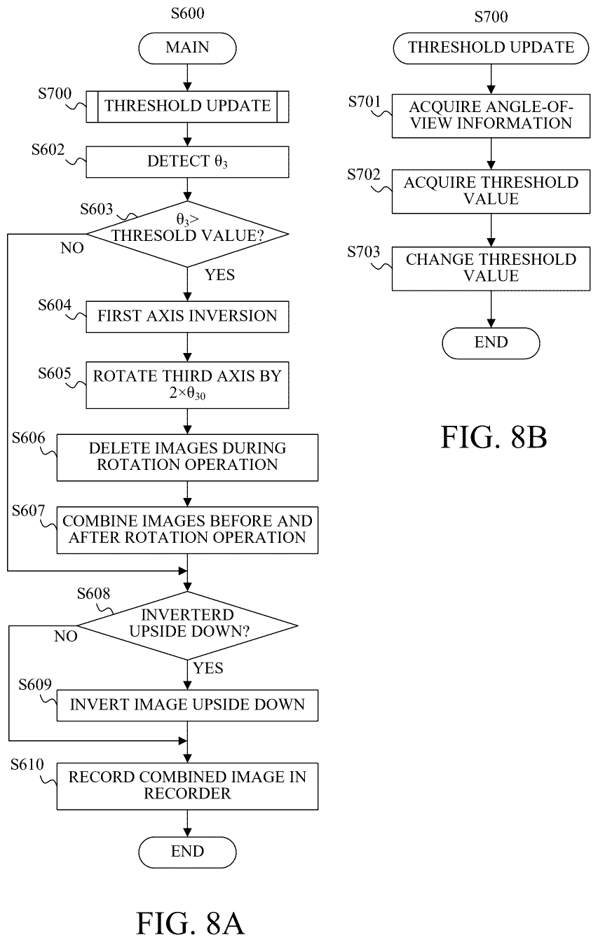

A flowchart in FIG. 8A illustrates the processing executed by the rotation control unit 230 as a computer according to a program. In this processing, while imaging is continuing, the images 510 and 513 before and after the rotation operation of the first-axis and third-axis rotators 131 and 133 are connected together to generate the combined image 514, and the imaging light beam 500 is prevented from being shielded by the second-axis rotator 132. This combined image 514 is then recorded in the recorder 250. The combined image 514 may also be output to the outside and recorded in an external recorder. S stands for the step.

The rotation control unit 230, which starts processing in S600, performs threshold update processing in S700. The threshold update processing will be described later. After the threshold update processing, the rotation control unit 230 acquires the third-axis rotation angle θ₃ from the rotation angle detector 211 in S602.

Next, in S603, the rotation control unit 230 determines whether the third-axis rotation angle θ₃ is greater than the threshold value θ₃₀. In a case where θ₃>θ₃₀, the rotation control unit 230 proceeds to S604 and rotates the first-axis rotator 131 around the first axis A₁ to invert the movable unit 120. Furthermore, in S605, the rotation control unit 230 rotates the third-axis rotator 133 around the third axis A₃ so that θ₃ becomes 2×θ₃₀.

Then, in S606, the rotation control unit 230 deletes the images 511 and 512 during the rotation operation as described in FIG. 7, and in S607 connects (combines) the images 510 and 513 before and after the rotation operation.

In a case where θ₃ is equal to or less than θ₃₀ in S603 or after the images 510 and 513 before and after the rotation operation are combined in S607, the rotation control unit 230 proceeds to S608.

In S608, the rotation control unit 230 determines the vertical attitude of the movable unit 120 using the shake detector 330. In a case where the vertical attitude of the movable unit 1120 is upside down as illustrated in FIG. 5D, the rotation control unit 230 proceeds to S609, where it inverts the object 122d upside down as described in FIGS. 6B and 6C to generate the image 121e. Then, the flow proceeds to S610. In a case where the vertical attitude of the movable unit 1120 is not upside down, the rotation control unit 230 proceeds directly to S610.

In S610, the rotation control unit 230 stores in the recorder 250 the combined image 514 obtained by connecting the images 510 and 513 before and after the rotation operation in S607 and the image 121a acquired by the camera 300 or the image 121e inverted upside down in S609. Then, this flow ends.

A flowchart in FIG. 9B illustrates the threshold update processing executed in S700. After the threshold update processing is started, the rotation control unit 230 acquires the angle-of-view information of the optical system from the angle-of-view information acquiring unit 422 via the lens control unit 430 in S701.

Next, in S702, the rotation control unit 230 acquires a threshold value θ₃ corresponding to the angle-of-view information acquired in S701 from the recorder 250 in which the threshold value θ₃ for each angle-of-view information has been previously stored.

Next, in S703, the rotation control unit 230 changes the previously set threshold value θ₃ to the one acquired in S702. Then, the flow proceeds to S602.

As described above, in a case where the third-axis rotation angle θ₃ is greater than the threshold value θ₃₀, the gimbal camera 100 according to this embodiment causes the first-axis and third-axis rotators 131 and 133 to perform a rotation operation while continuing imaging. The combined image 514 obtained by connecting the images 510 and 513 before and after the rotation operation is stored in the recorder 0. This series of operations is automatically performed by the gimbal camera 100. Thereby, the imaging light beam 500 can be prevented from being shielded by the second-axis rotator 132 without requiring the user to perform arduous operations or interrupt imaging.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

The gimbal apparatus according to this embodiment can prevent an imaging light beam from being shielded by a gimbal structure (second drive unit) without requiring a user manual operation or interruption of imaging.

What is claimed is:

1. A gimbal apparatus comprising:
a body portion;
a first drive unit configured to rotate a first support portion relative to the body portion about a first axis;
a second drive unit configured to rotate a second support portion supporting an imaging unit about a second axis orthogonal to the first axis relative to the first support portion;
a third drive unit configured to rotate the imaging unit about a third axis orthogonal to the first axis and the second axis relative to the second support portion;
a detector configured to detect a rotation angle about the third axis that an optical axis of the imaging unit makes relative to a second-axis orthogonal plane orthogonal to the second axis and including the third axis;
a memory storing instructions; and
a processor that, upon execution of the instructions, is configured to control the first drive unit, the second drive unit, and the third drive unit,
wherein in a case where the rotation angle becomes higher than a predetermined angle from the second-axis orthogonal plane toward a second drive unit side during imaging by the imaging unit, the processor is configured to:
drive the first drive unit so that the second drive unit rotates to an opposite position to the second-axis orthogonal plane while the imaging unit continues to perform imaging, and
drive the third drive unit so that the rotation angle from the second-axis orthogonal plane to an opposite side of the second drive unit with respect to the opposite position is the predetermined angle.

2. The gimbal apparatus according to claim 1, wherein the predetermined angle is an angle smaller than an angle at which a light beam entering the imaging unit is shielded by the second drive unit.

3. The gimbal apparatus according to claim 1, further comprising a processing unit configured to process an image acquired by the imaging unit,
wherein the processing unit is configured to generate a combined image by connecting images acquired before and after the first drive unit and the third drive unit are driven while the imaging is continued.

4. The gimbal apparatus according to claim 3, further comprising a recorder configured to record the combined image.

5. The gimbal apparatus according to claim 3, further comprising a determining unit configured to determine a vertical attitude of the imaging unit, and
wherein the processing unit is configured to invert the combined image upside down in a case where the vertical attitude is inverted.

6. The gimbal apparatus according to claim 1, wherein an angle of view of the imaging unit is variable, and
wherein the processor is configured to change the predetermined angle according to the angle of view.

7. A gimbal image pickup apparatus comprising:
the gimbal apparatus according to claim 1; and
the imaging unit.

8. A control method of a gimbal apparatus that includes a body portion, a first drive unit configured to rotate a first support portion relative to the body portion about a first axis, a second drive unit configured to rotate a second support portion supporting an imaging unit about a second axis orthogonal to the first axis relative to the first support portion, and a third drive unit configured to rotate the imaging unit about a third axis orthogonal to the first axis and the second axis relative to the second support portion, the control method comprising:
detecting a rotation angle about the third axis that an optical axis of the imaging unit makes relative to a second-axis orthogonal plane orthogonal to the second axis and including the third axis, and
controlling the first drive unit, the second drive unit, and the third drive unit,
wherein in a case where the rotation angle becomes higher than a predetermined angle from the second-axis orthogonal plane toward a second drive unit side during imaging by the imaging unit, controlling includes:
driving the first drive unit so that the second drive unit rotates to an opposite position to the second-axis orthogonal plane while the imaging unit continues to perform imaging, and
driving the third drive unit so that the rotation angle from the second-axis orthogonal plane to an opposite side of the second drive unit with respect to the opposite position is the predetermined angle.

9. A non-transitory computer-readable storage medium storing a program that causes a computer to execute the control method according to claim 8.
